(19) United States
(12) Patent Application Publication
(10) Pub. No.: US 2009/0107963 A1
(43) Pub. Date: Apr. 30, 2009

(54) Laser Processing Machine and Method

(75) Inventor: Martin Lambert, Korb (DE)

Correspondence Address: FISH & RICHARDSON PC, P.O. BOX 1022, MINNEAPOLIS, MN, 55440-1022, US

(73) Assignee: TRUMPF WERKZEUGMASCHINEN GMBH + CO. KG, Ditzingen (DE)

(21) Appl. No.: 12/258,945

(22) Filed: Oct. 27, 2008

Related U.S. Application Data
(63) Continuation-in-part of application No. PCT/EP2006/003957, filed on Apr. 28, 2006.

(51) Int. Cl. B23K 26/16; B23K 26/02

(52) U.S. Cl. 219/121.67; 219/121.83

(57) ABSTRACT

A laser processing machine includes a laser processing head including a beam guide for deflecting and/or focusing laser radiation onto a workpiece; a thermo-sensitive monitoring sensor system for an optical component of the beam guide; and an evaluation unit connected to a machine control of a laser generator that produces the laser radiation and configured to receive and process the data acquired by the monitoring sensor system. The evaluation unit attributes an increase in the temperature of the optical component of the beam guide due to laser radiation reflected from the workpiece to defective cutting.

### CROSS REFERENCE TO RELATED APPLICATION

This application claims priority under 35 U.S.C. § 120 to and is a continuation in part of PCT/EP2006/003957, filed on Apr. 28, 2006. This priority application is hereby incorporated by reference in its entirety.

### TECHNICAL FIELD

The invention relates to a laser processing machine.

### BACKGROUND

Defective laser cutting may result in workpieces that are not cut out completely. The term “defective” refers here to a cut that has not been made or that has been only partially made. Similarly, if separation is not complete, components of the laser processing head, especially the optical components of the beam guide, or other, adjoining elements, may be put at risk from the radiation reflected from the workpiece.

### SUMMARY

In some general aspects, a laser processing machine includes a laser processing head including a beam guide for deflecting, focusing, or deflecting and focusing laser radiation onto a workpiece; a thermo-sensitive monitoring sensor system for an optical component of the beam guide; and an evaluation unit connected to a machine control of a laser generator that produces the laser radiation and configured to receive and process the data acquired by the monitoring sensor system. The evaluation unit attributes an increase in the temperature of the optical component of the beam guide due to laser radiation reflected from the workpiece to defective cutting.

Implementations can include one or more of the following features. For example, the optical component of the beam guide can be an aperture plate. The aperture plate can be disposed in an intermediate focus of the laser radiation propagating in the direction towards the workpiece.

The monitoring sensor system can provide direct temperature monitoring at the optical component. The monitoring sensor system can provide indirect temperature monitoring of the optical component at a component that neighbors the optical component.

The evaluation unit can include means for the immediate or delayed switching-off or correction of the laser processing in dependence on the temperature of the optical component.

The monitoring sensor system can provide temperature monitoring in a contacting manner using a thermocouple contacting one or more of the optical component and a component neighboring the optical component. The monitoring sensor system can provide temperature monitoring in a non-contacting manner using a pyrometer.

In another general aspect, defective cutting in laser processing is detected by monitoring a temperature of a component of a beam guide of a laser processing head that directs laser light to a workpiece; and attributing an increase in the temperature of the component due to radiation reflected from the workpiece to defective cutting.

Implementations can include one or more of the following features. For example, the laser processing can be switched off if a pre-defined temperature limit is exceeded. The laser processing can be switched off immediately. The laser processing can be switched off after a delay.

The laser processing can be corrected if a pre-defined temperature limit is exceeded. The laser processing can be corrected by adjusting parameters of the laser beam. The parameters of the laser beam can be adjusted by adjusting one or more of a power, a shape, and a location of the laser beam at the workpiece.

The laser processing can be altered if a pre-defined temperature limit is exceeded, where different temperature limits are associated with different alterations in the laser processing.

The laser processing machine and a method described herein enable defective cutting to be detected and make appropriate process control possible in a reliable manner and with a minimum of expenditure.

The laser processing machine, for example, for laser beam cutting, includes a laser processing head, a beam guide within the laser processing head for deflecting and/or focusing the laser radiation onto a workpiece, a thermo-sensitive monitoring sensor system for an optical component of the beam guide, and an evaluation unit, connected to the machine control, for processing the acquired data, in which the evaluation unit attributes an increase in temperature or another measurable variable associated therewith/resulting therefrom in the optical component of the beam guide due to the radiation reflected from the workpiece to defective cutting. The method detects defective cutting in laser processing, in which the increase in the temperature of a component of the beam guide due to radiation reflected from the workpiece is monitored.

In the case of defective cutting, a large proportion of the laser light on the molten pool in the kerf is reflected. By a suitably adapted configuration of the beam guide and its components, the effects of the radiation reflected from the workpiece can be detected by a thermo-sensitive monitoring sensor system and evaluated by an evaluation unit. The results of that evaluation are used to regulate the laser processing machine, as described below.

The optical components of the beam guide deflect and/or reflect the reflected radiation (that is, the radiation or laser light reflected on the molten pool at the workpiece). As a result, the radiation reflected from the workpiece may be shaped locally in such a way that its dimension perpendicular to/radially with respect to the beam axis exceeds that of the laser beam propagating in the direction towards the workpiece. The optical (or other) components of the beam guide situated at that location are heated beyond the normal working temperature. With early detection of the rise in temperature, defective cutting can be reliably discovered, and the process control is able to react by way of the evaluation unit. Conceivable control options are, for example, immediate or delayed switching-off or correction and combinations thereof, in dependence on defined limits. It is also possible to define a number of temperature limits and the control procedures associated therewith (graded scale).

For example, it is conceivable in the case of a slight increase in temperature first to increase the sampling rate of the monitoring sensor system and then to perform correction of the laser processing if the temperature further increases beyond the next limit value. If the temperature does not fall to the normal/tolerable processing level again, laser processing is discontinued by switching off the laser processing machine. These and other control steps may be carried out both during processing of one workpiece and within a workpiece series (control step is carried out from workpiece to workpiece).

In some implementations, the component monitored is an aperture plate within the beam guide of the laser processing head. In that case, corresponding temperature changes due to radiation reflected from the molten material are detected with little delay because the aperture plate is positioned in the vicinity of an intermediate focus such that the intensity of the radiation is high, and can lead to a rapid change in the temperature of the aperture plate.

If that aperture plate is preferably disposed in or near an intermediate focus of the radiation propagating in the direction towards the workpiece, its aperture may be kept as small as possible. The smaller the aperture, the sooner the reflected radiation will be able to lead to heating of the aperture plate. This may also mean that the measuring sensitivity will thereby be increased.

Temperature measurement at the components to be monitored may, in addition, be performed directly or indirectly. In the case of direct measurement, the temperature is sensed at the component monitored. If that is not possible for lack of accessibility or for other reasons (from the point of view of production engineering, economics or otherwise), it is possible, for example, to record the temperature of a (neighboring) component that allows inferences to be made about the temperature or a temperature change of the optical component. Conceivable strategies in this case are, for example, temperature monitoring of the aperture plate mounting or monitoring of the characteristic values of the cooling system for the aperture plate (for example, temperature, flow rate, etc. . . . ).

The temperature can be measured in a contacting manner using a thermoelement, for example, a thermocouple, which is a simple form of monitoring. If that is not possible, non-contacting measuring methods, for example, by way of the use of a pyrometer, can be employed.

### BRIEF DESCRIPTION OF THE DRAWINGS

FIG. 1 is a side view of a first laser processing machine with means for detecting defective cutting;

FIG. 2 is a side view of a second laser processing machine with means for detecting defective cutting;

FIG. 3 is a longitudinal cross sectional view of a laser processing head of the laser processing machine of FIG. 1 or 2;

FIG. 4 is a longitudinal cross sectional view of a detail of the laser processing head with direct temperature monitoring;

FIG. 5 is a longitudinal cross sectional view of a detail of the laser processing head with indirect temperature monitoring;

FIG. 6 is a longitudinal cross sectional view of a detail of the laser processing head with non-contacting, direct temperature monitoring;

FIG. 7 is a longitudinal cross sectional view of a detail of the laser processing head with non-contacting, indirect temperature monitoring; and

FIG. 8 is a flow chart of a procedure for detecting defective cutting in laser processing using the laser processing machines described in FIGS. 1-7.

### DETAILED DESCRIPTION

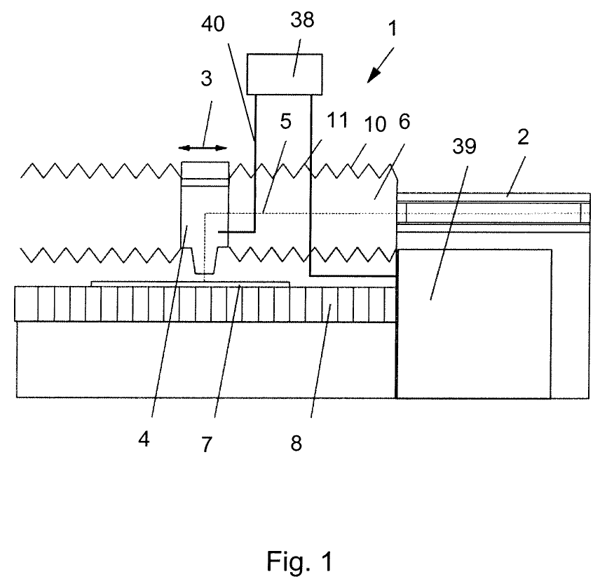

FIG. 1 shows a laser processing machine 1 (for example, a CO₂ laser processing machine) having a laser generator 2 and a laser processing head 4 that is movable relative thereto in the direction of the double-headed arrow 3. A laser beam 5 generated by the laser generator 2 is passed from the laser generator 2 through a beam-guiding chamber 6 to the processing head 4 and is there directed through use of a beam guide internal to the processing head 4 onto a workpiece 7 to be processed. The beam guide is a combination of optical elements that deflect, reflect, and/or focus the laser beam 5 within the laser processing head 4. The workpiece 7 can be a metal sheet and can be laid on a workpiece support 8 of the laser processing machine 1.

The effects of the radiation reflected from the workpiece 7 in the event of defective cutting can be detected, evaluated, and used for control purposes by monitoring the temperature of components of the beam guide of the laser processing head 4. This monitored temperature (or a value that is indicative of the monitored temperature) is sent to an evaluation unit 38 through a data connection 40 (which can be a wired or wireless data connection).

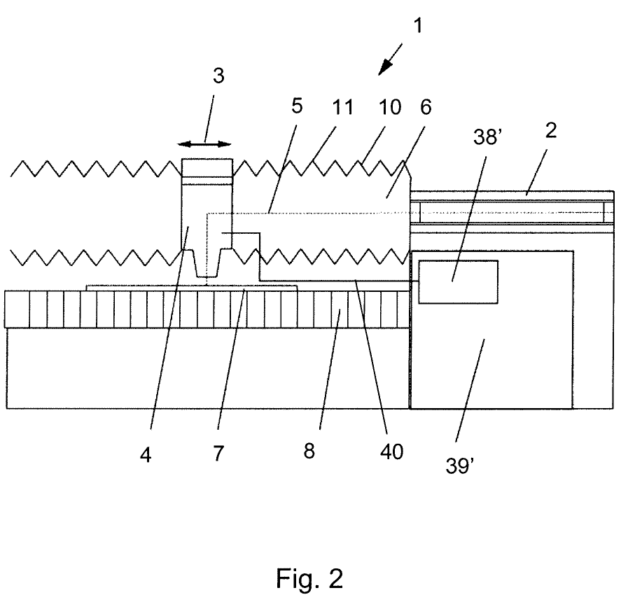

If a defined temperature limit is exceeded, the evaluation unit 38 then gives the appropriate machine command to a machine control 39, which puts the control measure into effect. The machine control 39 is a general control system of the laser processing machine 1, and it includes control for the laser generator 2. The evaluation unit 38 may be understood as being a separate unit or the evaluation unit 38′ is, as shown in FIG. 2, a component part of the machine control 39′.

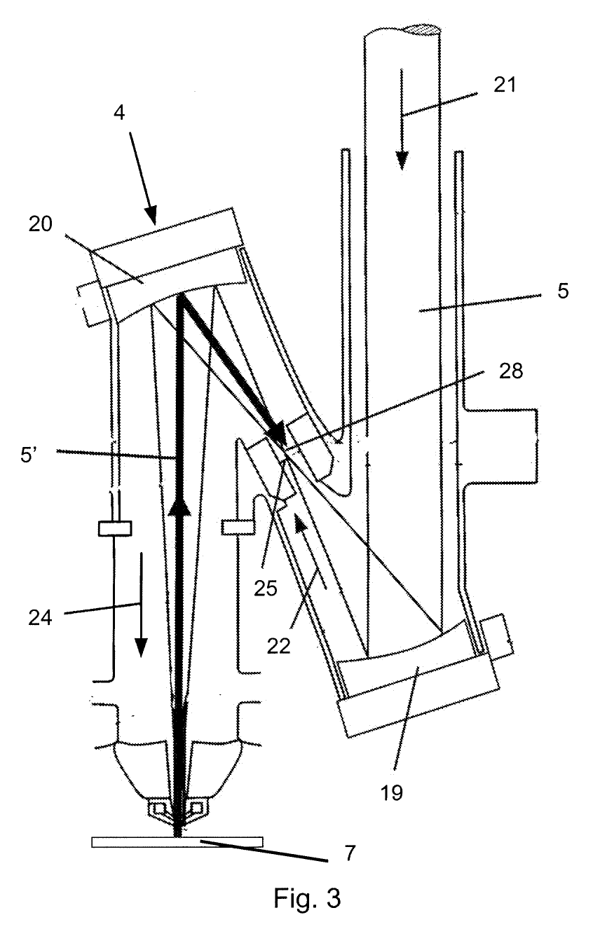

Coming from the laser generator 2 in the direction of the arrow 21, the laser light 5 in the laser processing head 4 is focused as shown in FIG. 3 by a parabolic mirror 19 in an intermediate focus in the direction of the arrow 22, is directed through an intermediate aperture plate 25, and subsequently impinges on an ellipsoidal mirror 20 which focuses the laser light 5 in the direction of the arrow 24 for the actual processing operation.

In the event of defective cutting, a large proportion of the laser light 5 on the molten pool in the kerf of the workpiece 7 is reflected into the laser processing head 4 and impinges on the ellipsoidal mirror 20 as laser light 5′. The light 5′ coming from the molten pool almost in the shape of a point is projected backwards into the intermediate focus 28. Since the molten material forms an undefined reflective surface, a relatively large focus spot is produced at the location of the intermediate aperture plate 25. The light then impinges partly on and thereby heats the intermediate aperture plate 25.

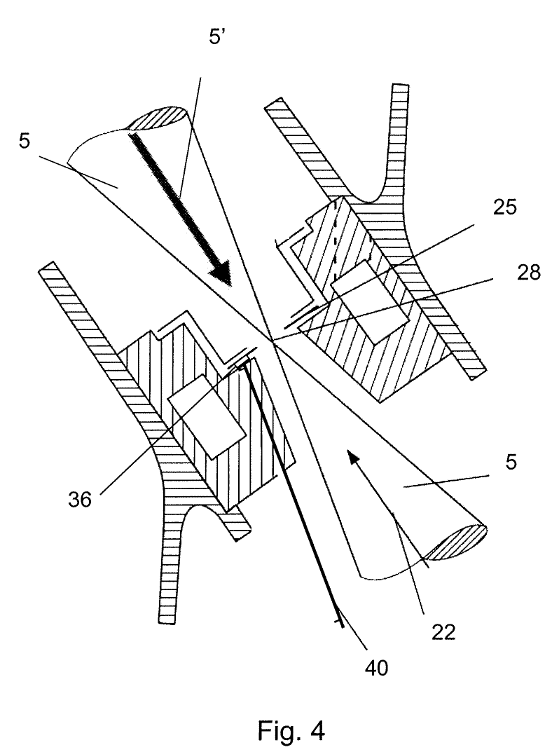

The monitoring of an optical component of the beam guide of the processing head is performed in FIG. 4 directly at the aperture plate 25 by temperature measurement in a contacting manner (that is, using a device that directly contacts a component to be measured), in this case by way of a thermoelement 36, for example, a thermocouple.

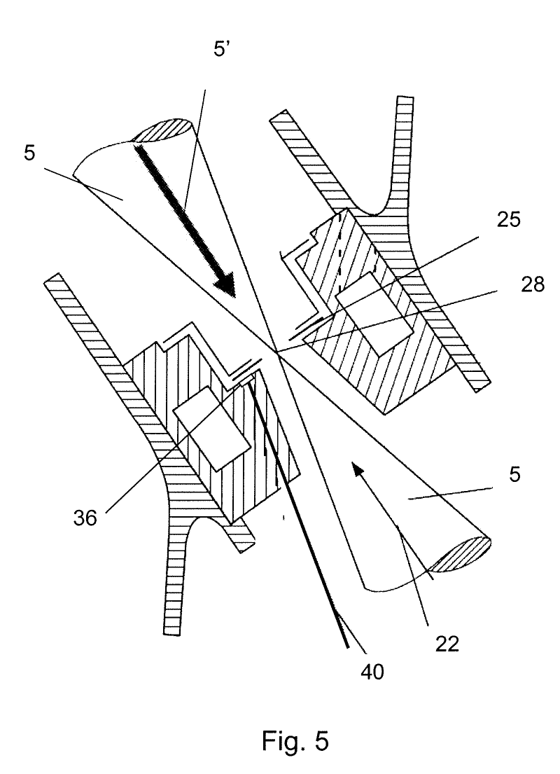

If accessibility, the material, or other circumstances do not permit direct contact measurement, where “direct” means that a component that is measured is struck by the reflected laser light 5′, monitoring may also be carried out indirectly as shown in FIG. 5 by measuring the temperature of a neighboring component that is in thermal contact with the optical component (for example, a base 42 of the aperture plate 25), provided that the temperature increase brought about by the heating of the component that is actually to be monitored can equally reliably be attributed to defective cutting.

Apart from measurement in a contacting manner, it is also possible for non-contacting (that is, using a device that does not directly contact a component to be measured), primarily optical, measuring systems, such as a pyrometer, to be employed as the monitoring sensor system.

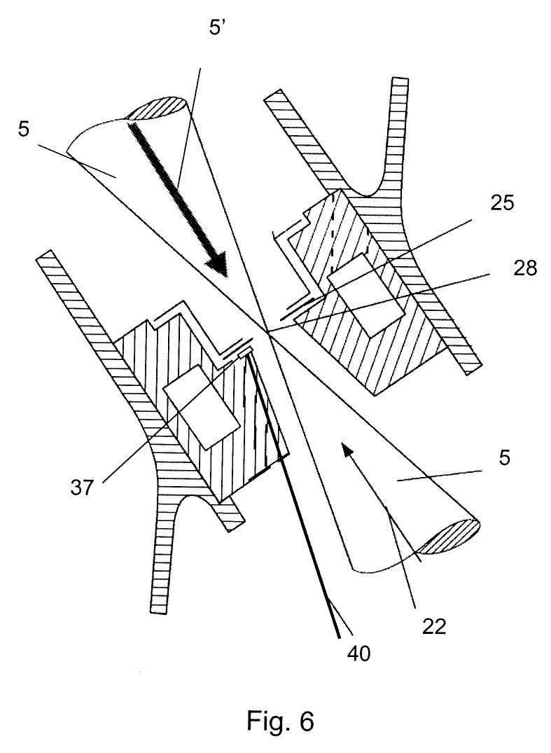

In FIG. 6, measurement is carried out directly at the aperture plate, the pyrometer 37 being oriented in such a manner that it absorbs the thermal radiation in the direction towards the laser generator 2.

Correspondingly, positioning of the pyrometer on the side of the optical component facing the workpiece is also possible. This equally applies to measuring in a contacting manner.

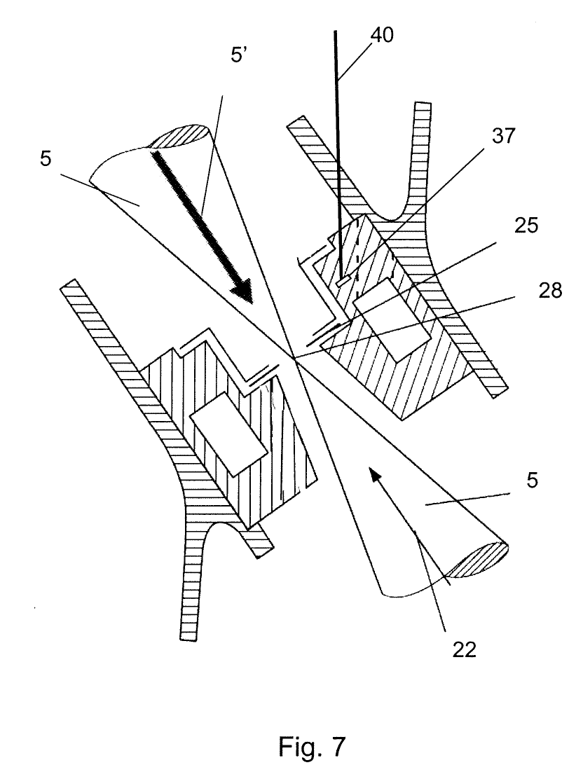

If the component to be monitored is not accessible or if other reasons argue against direct measurement, both non-contacting measurement and contacting measurement may be carried out as shown in FIG. 7 by way of recording the thermal radiation indirectly at a neighboring component.

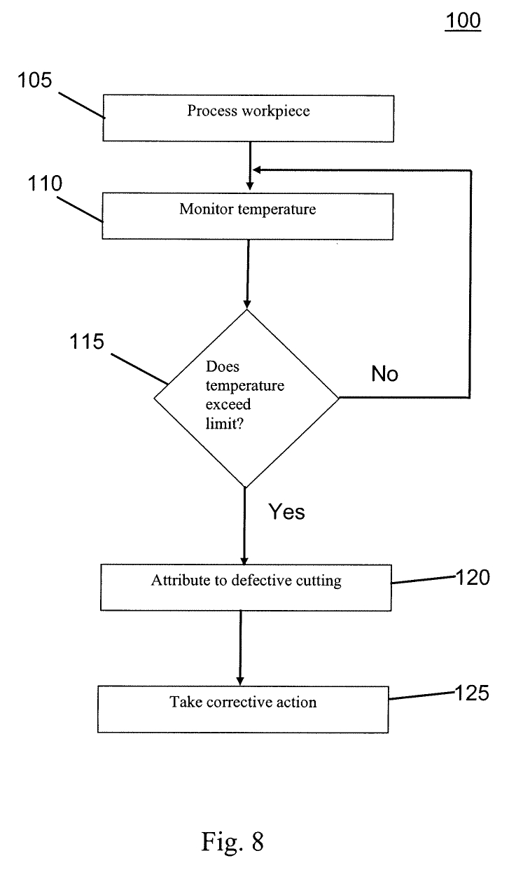

Referring to FIG. 8, a process 100 is performed for detecting defective cutting in laser processing using, for example, the laser processing machines of FIGS. 1-7. The workpiece 7 is processed (step 105) using the laser processing machine 1 by directing the laser beam 5 produced from the laser generator 2 through the laser processing head 4, which adjusts the laser beam 5 properties and directs the laser beam 5 to the workpiece 7. During the processing, the temperature of an optical component within a beam guide of the laser processing head 4 is monitored using a thermo-sensitive monitoring sensor system (step 110). If the evaluation unit 38 (or any suitable control or data device) determines that the temperature exceeds a pre-defined limit or threshold (step 115), then the evaluation unit 38 assumes that the excessive temperature at the optical component is due to laser radiation 5′ reflected from the workpiece 7 because of defective cutting (step 120) and the machine control 39 is directed to take corrective action on the laser generator 2 to adjust the laser beam 5 that impinges upon the workpiece 7 (step 125). Corrective action can include immediate or delayed switching off of the laser generator 2 through use of the machine control 39, adjustment of the parameters, for example, power, of the laser beam 5, and/or adjustment of the shape or location of the laser beam 5 at the workpiece 7. For example, the shape (that is, the area) of the laser beam 5 that impinges upon the workpiece 7 can be adjusted by changing the distance between the workpiece 7 and the laser processing head 4. Moreover, the corrective action can be done in an automated fashion, that is, without manual feedback from a user. If the evaluation unit 38 determines that the temperature does not exceed the pre-defined limit (step 115), then the temperature of the optical component continues to be monitored (step 110).

What is claimed is:

1. A laser processing machine comprising:
a laser processing head including a beam guide that deflects, focuses, or deflects and focuses laser radiation onto a workpiece;
a thermo-sensitive monitoring sensor system directly or indirectly coupled to an optical component of the beam guide; and
an evaluation unit connected to a machine control of a laser generator that produces the laser radiation and configured to receive and process the data acquired by the monitoring sensor system;
wherein the evaluation unit attributes an increase in the temperature of the optical component of the beam guide due to laser radiation reflected from the workpiece to defective cutting.

2. The laser processing machine of claim 1, wherein the optical component of the beam guide is an aperture plate.

3. The laser processing machine of claim 2, wherein the aperture plate is disposed in an intermediate focus of the laser radiation propagating in the direction towards the workpiece.

4. The laser processing machine of claim 1, wherein the monitoring sensor system provides direct temperature monitoring at the optical component.

5. The laser processing machine of claim 1, wherein the monitoring sensor system provides indirect temperature monitoring of the optical component at a component that neighbors the optical component.

6. The laser processing machine of claim 1, wherein the evaluation unit includes means for the immediate or delayed switching-off or correction of the laser processing in dependence on the temperature of the optical component.

7. The laser processing machine of claim 1, wherein the monitoring sensor system provides temperature monitoring in a contacting manner using a thermocouple contacting one or more of the optical component and a component neighboring the optical component.

8. The laser processing machine of claim 1, wherein the monitoring sensor system provides temperature monitoring in a non-contacting manner using a pyrometer.

9. A method for detecting defective cutting in laser processing, the method comprising:
monitoring a temperature of a component of a beam guide of a laser processing head that directs laser light to a workpiece; and
attributing an increase in the temperature of the component due to radiation reflected from the workpiece to defective cutting.

10. The method of claim 9, further comprising switching off the laser processing if a pre-defined temperature limit is exceeded.

11. The method of claim 10, wherein the switching off of the laser processing is immediate.

12. The method of claim 10, wherein the switching off of the laser processing is delayed.

13. The method of claim 9, further comprising correcting the laser processing if a pre-defined temperature limit is exceeded.

14. The method of claim 13, wherein correcting the laser processing includes adjusting parameters of the laser beam.

15. The method of claim 14, wherein adjusting parameters of the laser beam includes adjusting one or more of a power, a shape, and a location of the laser beam at the workpiece.

16. The method of claim 9, further comprising altering the laser processing if a pre-defined temperature limit is exceeded, wherein different temperature limits are associated with different alterations in the laser processing.
